(19) United States
(12) Patent Application Publication
(10) Pub. No.: US 2024/0250338 A1
(43) Pub. Date: Jul. 25, 2024

(54) Battery Module with Battery Holder and Immersion Fluid

(71) Applicant: POWER.GLOBAL, PBC, Pasadena, CA (US)

(72) Inventor: W. Porter Harris, Pasadena, CA (US)

(21) Appl. No.: 18/421,179

(22) Filed: Jan. 24, 2024

Related U.S. Application Data
(60) Provisional application No. 63/481,534, filed on Jan. 25, 2023.

(51) Int. Cl. H01M 10/6556; H01M 10/613; H01M 50/213

(52) U.S. Cl. CPC H01M 10/6556; H01M 10/613; H01M 50/213

(57) ABSTRACT

A battery modules includes a plurality of battery cells and a cell holder. The cell holder includes a plurality of openings that extends from a first surface of the cell holder to an opposite surface of the cell holder, each of the plurality of openings comprising a cross-section with a circular portion and an extended portion that extends from the circular portion. Each of the plurality of battery cells are housed in a respective one of the plurality of openings and a space between each of the plurality of battery cells and an interior surface of each of the plurality of openings of the cell holder forms a path for a fluid to flow along a length of a respective one of the plurality of battery cells. The path includes at least the extended portion of the respective opening.

### CROSS-REFERENCE TO RELATED APPLICATIONS

This application claims the benefit of U.S. Provisional Patent Application No. 63/481,534, filed on Jan. 25, 2023, which application is incorporated herein by reference.

### BACKGROUND

A battery cell may include a chemistry that converts electrical energy into chemical energy and store this chemical energy internally. When a battery cell charges, a voltage or current source may be connected to terminals of the battery cell. A current may flow into the battery cell thereby storing electrical energy as chemical energy within the battery cell. When a load is placed on the battery cell, the chemical energy can be converted back to electrical energy and provided from the battery cell to the load, in what may be referred to as discharging. Various battery technology exists that utilizes different chemistries to store the energy, such as lithium-ion, nickel cadmium, lead-acid, or other battery technology.

Battery cells are popular for a variety of energy storage applications such as cell phones, laptops, and electric vehicles. Battery cells can be grouped and managed as units which may be referred to as battery modules. These battery modules can be used to power vehicles, or to store energy for the utility grid, or for other applications.

### SUMMARY

Battery cells may generate thermal energy when charging or discharging. Thermal management and packing of battery cells can be a challenge. A battery module may include features as described herein that manage thermal energy of the cells, thereby improving the health, operational ability (e.g., power output), and safety of a battery module and its cells.

In some aspects, a battery module is described with a fluid immersion technology. A fluid is circulated through battery module to transfer thermal energy from or to each battery cell in a battery module. The battery module may include a battery cell holder that promotes even fluid flow over battery cells while holding each of a plurality of battery holders in place and providing structural integrity and strength to the battery module. The battery cell holder may have a plurality of openings to house the battery cells, where a geometry of each opening includes a fluid path along a length of each battery cell. Thermal energy may be transferred from each battery cell to the fluid, thereby transferring heat to or from battery cells.

The above summary does not include an exhaustive list of all embodiments of the present disclosure. It is contemplated that the disclosure includes all systems and methods that can be practiced from all suitable combinations of the various embodiments summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several embodiments of the disclosure here are illustrated by way of example and not by way of limitation in the figures of the accompanying drawings in which like references indicate similar elements. It should be noted that references to “an” or “one” embodiment in this disclosure are not necessarily to the same embodiment, and they mean at least one. Also, in the interest of conciseness and reducing the total number of figures, a given figure may be used to illustrate the features of more than one embodiment of the disclosure, and not all elements in the figure may be required for a given embodiment.

FIG. 1 shows an example battery module, in accordance with some embodiments.

FIG. 2 shows an example of an extruded layer that may form a portion of a battery holder, in accordance with some embodiments.

FIG. 3 shows an example of battery cells and the extruded layer, in accordance with some embodiments.

FIG. 4 shows an example of battery cells arranged in the cell holder, in accordance with some embodiments.

FIG. 5 shows an example of a battery module, in accordance with some embodiments.

FIG. 6 shows an example of an energy storage system, in accordance with some embodiments.

FIG. 7, FIG. 8, FIG. 9, and FIG. 10 show various examples of an opening of a battery cell holder, in accordance with some embodiments.

### DETAILED DESCRIPTION

The following description is of various exemplary embodiments, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended statements.

For the sake of brevity, conventional techniques for battery pack construction, configuration, and use, as well as conventional techniques for thermal management, operation, measurement, optimization, and/or control, may not be described in detail herein. Furthermore, the connecting lines shown in various figures contained herein are intended to represent exemplary functional relationships and/or physical couplings between various elements. It should be noted that alternative or additional functional relationships or physical connections may be present in a practical system or related methods of use.

In one aspect, a battery module may comprise a plurality of battery cells and a cell holder. The cell holder may include a plurality of openings that extends from a first surface of the cell holder to an opposite surface of the cell holder. Each of the plurality of openings may include a cross-section that has a circular portion and an extended portion that extends from the circular portion. Each of the plurality of battery cells may be housed in a respective one of the plurality of openings. A space between each of the plurality of battery cells and an interior surface of each of the plurality of openings of the cell holder may form a path for a fluid to flow along a length of a respective one of the plurality of battery cells. The path may include at least the extended portion of the respective hole. The path which may be formed by the gap between the battery and the interior surface of the cell holder may extend along the entire length of the battery formed by the extended portion of the respective hole. The extended portion may run along the entire length of the battery (from the first surface to the opposite surface), to provide a controlled fluid flow per battery cell.

In one aspect, an energy storage system may include a plurality of battery modules. The plurality of battery modules may be fluidly connected (e.g., ganged together). In some examples, the battery modules are fluidly connected in series. Additionally, or alternatively, the battery modules may be fluidly connected in parallel.

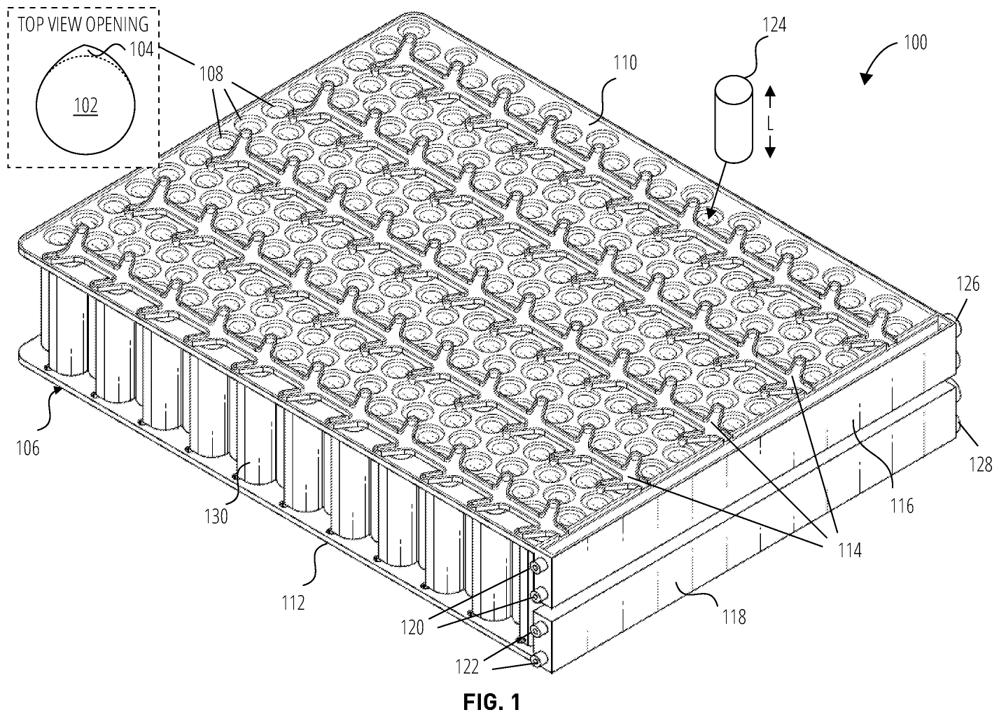

FIG. 1 shows an example battery module 100 in accordance with some embodiments.

A battery module 100 may include a plurality of battery cells 124. Each battery cell may have a cylindrical geometry. For example, each battery cell may have a circular base that extends along a length L of the battery cell, and planar or flat surfaces at opposite sides of the length L. Each battery cell may include a lithium-ion based chemistry. Each battery cell may be a rechargeable battery.

The battery module may include a cell holder 106. The cell holder 106 may include a plurality of openings 108. Each opening may extend from a first surface 110 of the cell holder to an opposite surface 112 of the cell holder. The first surface 110 may be referred to as a top surface and the opposite surface 112 may be referred to as a bottom surface. Each opening 108 may include a cross-section with a circular portion 102 and an extended portion 104 that extends from the circular portion. The cross-section may extend from the first surface 110 to the opposite surface 112. In some examples, the cross section of each opening may include at most one extended portion 104.

Each of the plurality of battery cells 124 are housed in a respective one of the plurality of openings 108. A space (e.g., a negative space or gap) between each of the plurality of battery cells and an interior surface of each of the plurality of openings of the cell holder may form a path for a fluid to flow along a length of a respective one of the plurality of battery cells (e.g., from the top surface 110 to the bottom surface 112 of the cell holder 106. The fluid path may include at least the extended portion 104 of the respective hole of the cell holder 106.

For example, when the battery cells are populated in the cell holder 106, fluid may flow in a path along the length L of each battery cell primarily in the extended portion 104 formed between the battery cell and the interior surface of the opening that the battery cell resides in. The fluid may be a liquid (e.g., a coolant, water, or other liquid).

The battery module 100 may include one or more channels 114 that are fluidly connected to the plurality of openings 108 at the first surface 110 of the cell holder (e.g., the top surface), to deliver the fluid to each of the plurality of openings. Similarly, although not shown, the opposite surface 112 may include second one or more channels that may be fluidly connected to each of the plurality of openings at the opposite surface 112, to receive the fluid from each of the plurality of openings 108. Each of the one or more channels may direct the fluid to one or more of openings so that each of plurality of openings 108 has fluid circulated to and from the battery residing in the opening. In some examples, each channel may direct fluid to each of the batteries along the path of the channel (e.g., directing fluid to a row of openings).

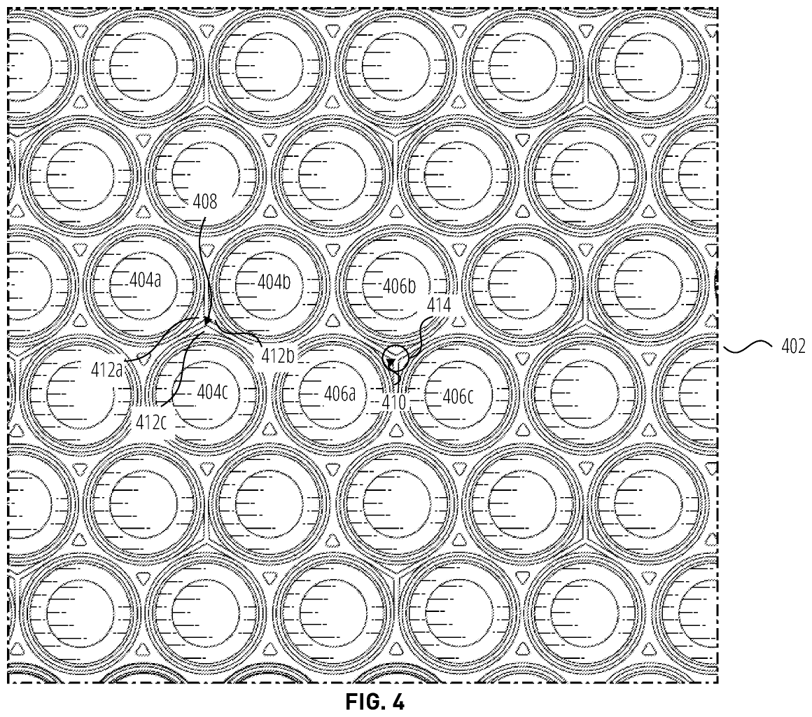

In some examples, the one or more channels may branch out to a group of openings and direct the fluid to a common portion of the group of openings. For example, the extended portions of adjacent openings may meet in a given group of openings (see, for example, FIG. 4) and the channel may deposit the fluid at a central location where the extended portions meet, and deposit the fluid at that single location to distribute the fluid to each of the openings in that group.

In some examples, the battery module 100 may include a supply manifold 116. The supply manifold may be fluidly connected to each of the plurality of openings at the first surface 110 of the cell holder. For example, the one or more channels 114 may fluidly extend from the supply manifold 116 and direct the fluid towards the extended portion 104 of each opening at the first surface 110 of the battery holder.

The battery module 100 may include a return manifold 118 that is fluidly connected to each of the plurality of openings at the opposite surface of the cell holder. For example, a second set of channels (not shown) or a single collection tray may be arranged at the opposite surface 112 to receive the fluid from each of the openings at the extended portion, and direct the fluid to the return manifold 118. The supply manifold 116 and return manifold 118 may be fluidly connected to an external fluid supply system (not shown) which may include a cooling system to cool the fluid and one or more pumps to pressurize the fluid to promote circulation of the fluid through the battery module 100.

In some examples, the supply manifold 116 includes one or more first supply ports 120 that is to receive fluid into the supply manifold. In some examples, the return manifold 118 may include a one or more first return ports 122 to deliver fluid out of the return manifold 118 (e.g., back to the external fluid supply system). In some examples, the one or more first supply ports 120 and the one or more first return ports 122 are arranged on a first exterior surface (e.g., the same surface) of the battery module, to allow for easier connectivity of fluid lines or other battery modules to the supply and return manifold. Further, the supply manifold 116 may optionally include one or more second supply ports 126. Return manifold 118 may optionally include one or more second return ports 128. Ports 126 and 128 may fluidly connect to a second battery module (e.g., a fluid series connection).

Each of the fluid ports (e.g., supply ports, return ports, or both) described may be a blind mate connector. Blind mate connectors can include spring-loaded connection mechanisms that allow for automatic mating based on applied force. Additionally, or alternatively, each of the fluid ports may be dripless connectors that automatically close when disconnected. Dripless connectors can include spring-loaded valves that automatically stop fluid flow when disconnected.

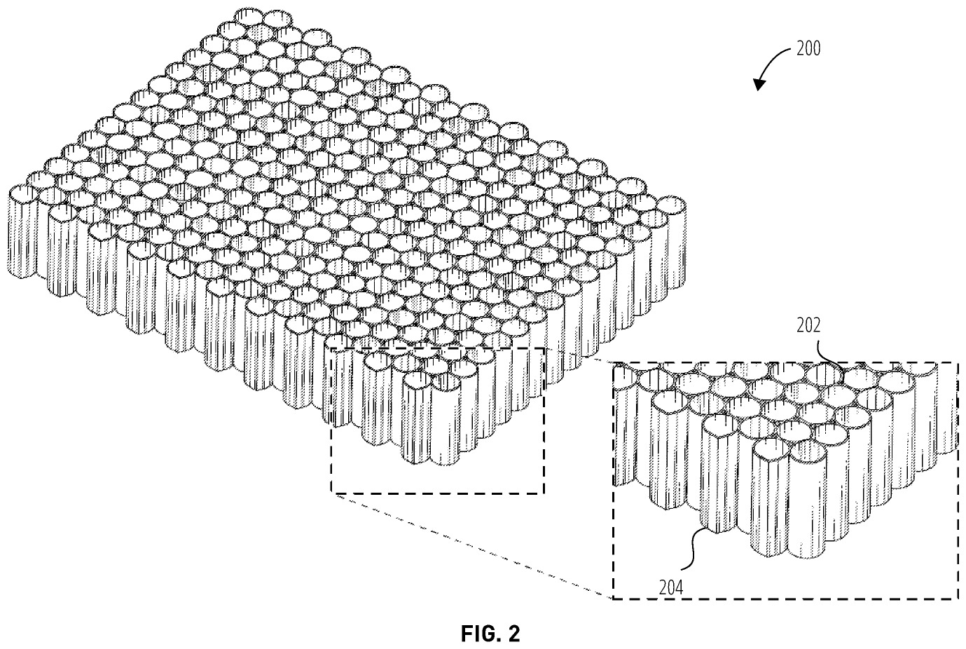

In some examples, the cell holder comprises a first layer (e.g., a first surface cap) that forms the first surface 110 of the cell holder, a second layer (e.g., a second surface cap) that forms the opposite surface 112 of the cell holder, and an extruded layer (e.g., 130) that is fixed between the first layer and the second layer. An example of the extruded layer 130 is shown in FIG. 2. The first surface cap, the second surface cap, and the extruded layer may be joined by fit, and adhesive, fasteners, or a combination thereof to form the cell holder.

In some examples, a geometry of the cell holder is determined to provide a thermal transfer to a first threshold and limit an amount of fluid through the cell holder to a second threshold. For example, as the size of the extended portion 104 increases, the thermal transfer also increases, as does the amount and flow of fluid in the battery module 100. The geometry of the opening (e.g., the size or shape of the extended portion 104) can be tuned to suit the application of a given battery module, to maximize thermal transfer while maintaining a desired fluid flow rate.

In some examples, the one or more channels 114 (and the one or more second channels on the opposite surface 112) may have a geometry (e.g., a thickness, length, or both) to increase or maximize the fluid flowing to and from the plurality of openings and direct a same amount of the fluid to each of the plurality of battery cells in each of the plurality of openings. For example, each of the openings may receive the same amount of fluid or same flow rate, regardless of the openings position (e.g., whether the opening is relatively upstream or downstream along the one or more channels).

The surface cap assemblies may include geometries (such as those described, or different geometries) that optimize the liquid flow path to locations within the honeycomb-like structure of the cell holder 106, and also optimize mass flow rate balance so that every channel within the honeycomb-like structure sees the same flow rate and fluid temperature. For example, assuming that ‘X’ number of channels 114 extend from manifold 116, they each may have the same flow rate and fluid temperature.

Further, the surface cap assemblies may include geometries (such as those described, or different geometries) which provide a flow path to and through the module so that multiple modules can be fluidly connected in a parallel or series configuration creating a parallel flow path all the way down to the cell level so that each channel sees the same liquid, mass flow rate, and fluid temperature.

In some examples, the cell holder 106 includes a low-density filler that compresses in response to an increase in fluid volume, and expands in response to a decrease in the fluid volume. The low-density filler material may include glass particles (e.g., spheres) to reduce weight and changes in volume. In some examples, the glass particles may be hollow, to further reduce weight and changes in volume.

The surface cap assembly may optionally include a lead frame (over molded electrical circuit made out of copper, aluminum or any other electrical conductor) component to connect the cells in an electrical configuration; series, parallel or series-parallel. The lead frame may connect to connect to the cells for voltage sensing, cell balancing, temperature sensing or any other sensing of the cells, fluid or any other elements of the module.

Although not shown, the battery module (e.g., 100 or other embodiments of the present disclosure) may comprise a plurality of battery cells that are electrically interconnected to provide a desired voltage and energy storage capacity (e.g., 42Vdc, 72Vdc, or other voltage). The battery module, particularly lithium ion-based battery modules, may include sensors for temperature monitoring, voltage monitoring, and current monitoring. The battery module may include analog and/or digital components such as temperature sensors, voltage sensors, current sensors, sensing circuits, a microprocessor, a transceiver, a communication bus, and/or other components. These components may be collectively understood as a battery management system (BMS).

A BMS may be configured to monitor the state of health (SOH) and/or state of charge (SOC) of a battery pack. The BMS and the plurality of battery cells may be packaged within a common housing (e.g., a housing that encases the various components of the battery module). Collectively, the battery cells, the housing and packaging of the battery cells, bus bars, wiring, connectors, BMS, and other components within or on the housing, may be referred to as a battery pack or battery module.

The surface cap assembly may optionally contain a printed circuit board assembly (PCBA), printed circuit board (PCB), or flex circuit used to connect to the cells for voltage sensing, cell balancing, temperature sensing or any other sensing of the cells, fluid or any other elements of the module. The surface cap assembly may be hermetically sealed with a connector or element that can interface with outside components.

FIG. 2 shows an example of an extruded layer 200 that may form a portion of a battery holder, in accordance with some embodiments.

The extruded layer 200 may include a honeycomb structure that serves as both a structural component to the battery module and holds each of the battery cells. The honeycomb structure may be formed from a repetitive network of interconnected walls that form the one or more holes (in the negative space between the walls. Further, as described, the extruded layer 200 may be fixed on opposing surfaces 202 and 204 to surface cap assemblies in a sealed manner (e.g., fluidly sealed or hermetically sealed or both). The battery holder with the extruded layer 200, the surface cap assemblies, and batteries housed within the battery holder provide structural stability to the battery module, by resisting forces in various directions, similar to a honeycomb core panel, thereby optimizing strength and reducing weight in the battery module.

In some examples, each battery cell is populated within the honeycomb-like structure of the extruded layer 200, and sealed in place by the surface cap assemblies (not shown) when fixed to the opposing surfaces 202 and 204, thereby sandwiching each battery cell in place within the respective hole in the battery holder.

Further, as described, the honeycomb structure of the extruded layer 202 may be geometrically designed (e.g., based on the shape of each opening) to optimize a liquid flow path between the battery cells and the cell holder (e.g., flow channels) such that thermal transfer is maximized while maintaining a desired amount of fluid and fluid flow, and reducing system weight.

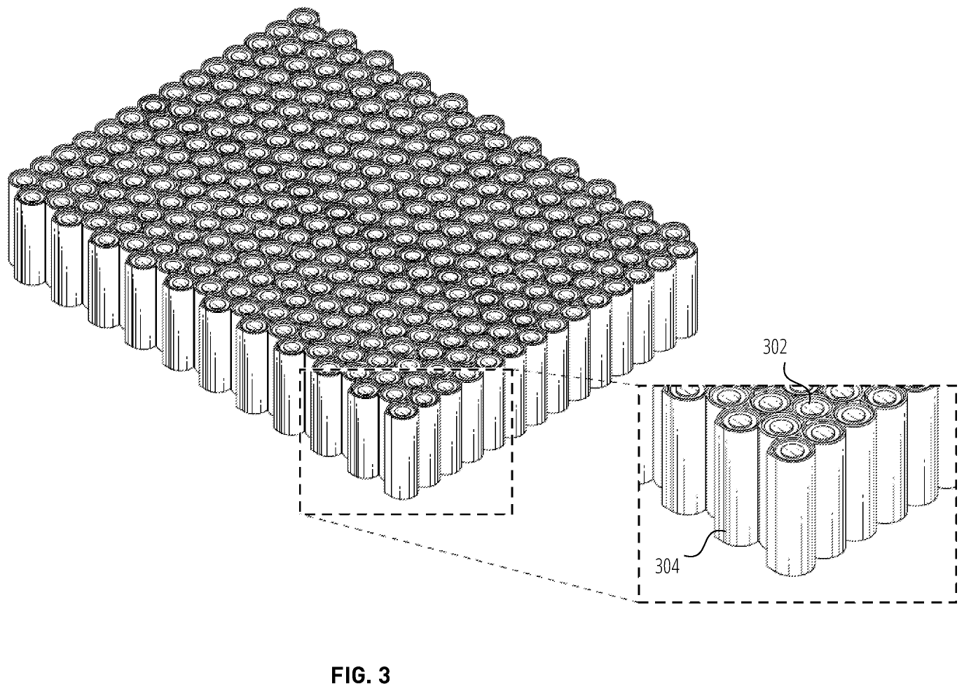

FIG. 3 shows an example of battery cells 302 as they reside in each opening of the extruded layer 304, in accordance with some embodiments.

In some examples, the extruded layer 304, as well as the surface cap assemblies and components that make up the assemblies (not shown), may comprise or be formed from plastic or other composite. As described, the battery holder may include the extruded layer 304 and surface cap assembles which may be fixed together via laser, hot plate welded, adhered using adhesive, or with fasteners, or a combination thereof. All components may be hermetically sealed together to ensure no liquid leakage.

In some examples, the extruded layer 304 may be plastic extruded or injection molded. The interior of the extruded layer 304 may optionally include a low-density filler material that compresses when the fluid increases in volume and expands as the fluid decreases in volume. The filler may reduce stress on the walls of the assembly due to the pressure increase of fluid with changes in temperature.

In some examples, the extruded layer or the entire battery holder assembly may be comprised of geometric elements that decrease pockets where air bubbles can get trapped. These geometric elements may enable multiple orientations that the battery module may occupy. For example, the battery module need not be arranged on a flat surface normal to the gravitational pull of Earth. The battery module may be used for terrestrial (high gravity) application, or for space use (micro gravity), and everything in-between.

FIG. 4 shows an example of battery cells arranged in groups in the cell holder 402, in accordance with some embodiments.

In some examples, adjacent openings may be arranged in the cell holder 402 to form one or more groups of openings. Each of the adjacent openings may have a respective extended portion that is directed towards a common region between the adjacent openings. As described in other examples, one or more channels may direct fluid to each opening and each cell. For clarity, the one or more channels are not illustrated in this figure, but can be seen in other figures (e.g., FIG. 1). The one or more channels may be configured to direct the fluid to a respective common region of a respective one of the one or more groups of openings, which may reduce the number of total channels and improve reliability.

For example, openings 404a, 404b, and 404c may be adjacent openings in the cell holder 402 where each of their respective extended portions 412a, 412b, and 412c extend towards a common region 408 that is located between the adjacent openings 404a, 404b, and 404c. In some examples, the common region 408 may be a point that is centered relative to the openings (404a, 404b, 404c) in the group. Adjacent openings may be referred to as ‘adjacent’ to each other when there are no other openings between them.

In some examples, as shown, each of the one or more groups of openings is formed by three adjacent openings (e.g., exactly three openings per group). For example, openings 404a, 404b, and 404c may form a first group of openings. Similarly, openings 406a, 406b, and 406c may form a second group of openings, and so on. As shown, the cell holder 402 may include a plurality of groups of openings that are side-by-side to form a repetitive pattern.

One or more channels may deposit fluid to the common region 408 and distribute the fluid evenly to each of openings 404a, 404b, and 404c. Further, the one or more channels may deposit the fluid deposit the fluid to the common region 410 and distribute the fluid evenly to each of openings 406a, 406b, and 406c. In some examples, the one or more channels may deposit the fluid in a cup 414 at the common region, where that cup may distribute the fluid to each of the extended regions of the openings in that group evenly. The cup 414 may be fixed directly over the common region of the respective group, to collect the fluid from the one or more channels, and distribute to the group.

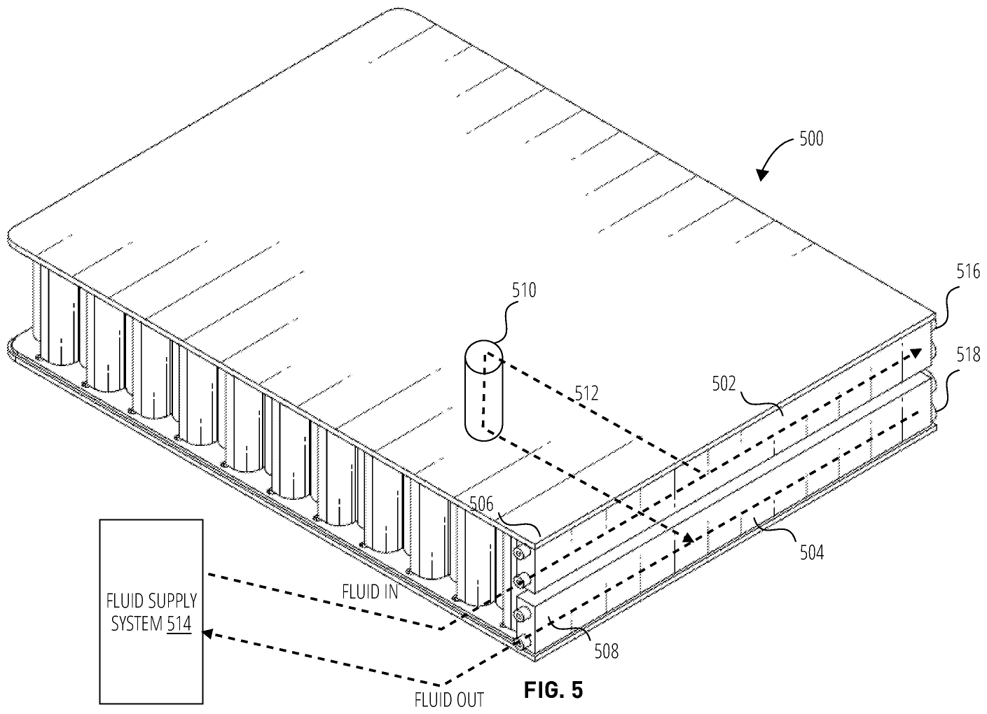

FIG. 5 shows an example of a battery module 500, in accordance with some embodiments. As described, battery module 500 may include a supply manifold 502 and a return manifold 504. The supply manifold may be fluidly connected to each of the plurality of openings at the first surface of the cell holder (e.g., through one or more channels), as described in other sections. Further, the return manifold 504 may be fluidly connected to each of the plurality of openings at the opposite surface of the cell holder (e.g., through a second set of one or more channels) to receive the fluid from each opening. Multiple fluid loops such as fluid loop 512 may extend from the supply manifold 502 to each battery cell (e.g., 510) and then back to the return manifold 504.

The inlet manifold 502 may include a first supply port 506 that may be fluidly connected to a supply line of the fluid supply system 514. The return manifold 504 may include a first return port 508 that may be fluidly connected to fluidly supply system 514. Fluid supply system 514 may be an external fluid supply system that includes cooling infrastructure (e.g., a chiller, a condenser, a fan, a refrigerator, etc.) to cool the fluid received from battery module 500. Further, fluid supply system 514 may include one or more pumps to circulate fluid to or from the battery module 500. In some examples, a fluid supply system 514 may circulate fluid to and from multiple battery modules.

In some examples, the first supply port 506 and the first return port 508 may be adjacently positioned on the same side of the battery module. This may help connecting fluid lines to the battery module. In some examples, the first supply port 506 may comprise a plurality of first supply ports. Similarly, the first return port 508 may comprise a plurality of first return ports.

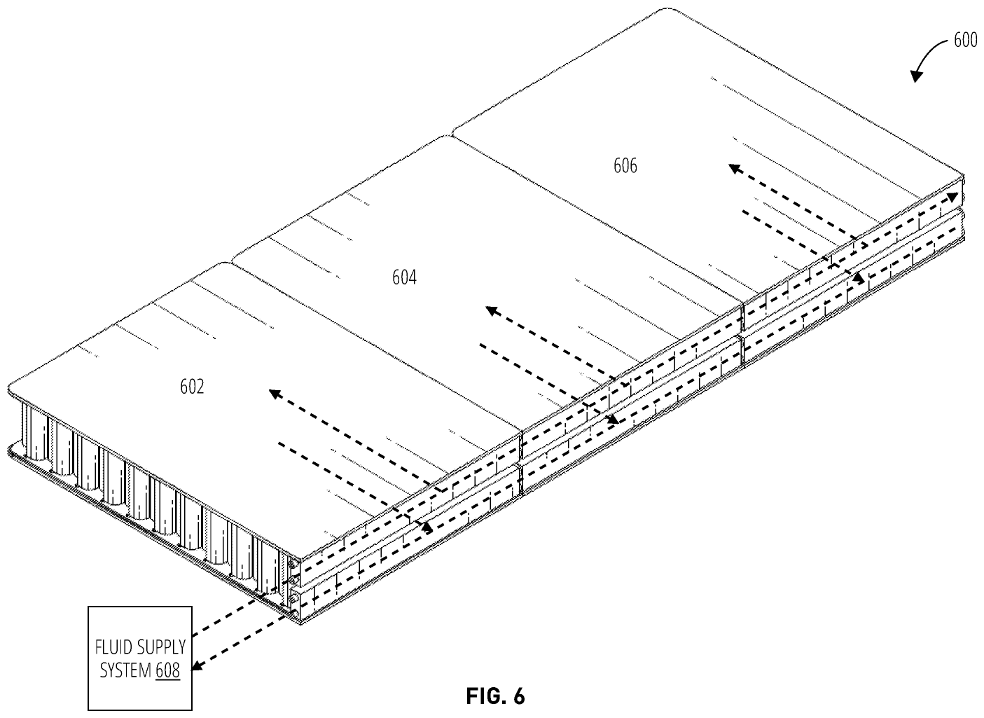

Optionally, the battery module 500 may comprise one or more second supply ports 516 of the supply manifold, and one or more second return ports 518 of the return manifold. The second supply ports and return ports may be arranged on a second side that is different (e.g., opposite) from the first side. The second supply port 516 may be a mating connector to the first supply port 506. Similarly, the second return port 518 may be a mating connector to the first return port 508. The ports and the manifolds are configured so that fluid is to flow from the first supply port to the second supply port and from the second return port to the first return port when battery modules are ganged together. For example, a first supply port and a second supply port of a second battery module (which may be the same as any of the embodiments described) may be fluidly connected to the battery module 500 via the second supply port 516 and the second return port 518. Such an example is shown in FIG. 6.

As described, the fluid ports may be a blind mate connectors that allow for automatic mating based on applied force. Additionally, or alternatively, each of the fluid ports may be dripless connectors that automatically close when disconnected.

FIG. 6 shows an example of an energy storage system 600, in accordance with some embodiments.

Energy storage system 600 may include a plurality of battery modules such as battery modules 602, 604, and 606. Each of those battery modules may correspond to embodiments described in other sections.

For example, each battery module may include a supply manifold and return manifold with fluid ports at opposite sides. The battery modules may be fluidly connected such that the supply manifold of battery module 602 becomes fluidly connected to the supply manifold of battery module 604. Further, the supply manifold of battery module 606 may be fluidly connected to the supply manifold of battery module 606, and so on. The same can be said for the return manifolds of the respective battery modules. Such a connection may be understood as a series connection, where the fluid flows from an upstream battery module to a downstream battery module, and back, while supplying fluid to the battery cells in the upstream and downstream battery module.

For example, a first supply port of the supply manifold on battery module 602 may connect to fluid supply system 608. A second supply port of the supply manifold (e.g., on an opposite side of battery module 602) may connect with to a first supply of the supply manifold on battery module 604. Similarly, a first return port of the return manifold on battery module 602 may connect to a return line of fluid supply system 608. A second return port of the return manifold (e.g., on an opposite side of battery module 602) may connect with to a first return port of the return manifold on battery module 604, and so on. With such a geometry (e.g., ports on opposing sides of the battery module), multiple battery module may be ganged together in a straight line, which may allow for improved distribution to electronics or other loads.

At least one of the battery modules (e.g., battery module 602) may be connected to fluid supply system 608. Because the battery modules may be connected directly to each other, fluid hardware such as conduit, connectors, etc., may be greatly reduced, and reliability may be improved due to reduced failure points.

In other examples, the battery modules may each be connected in parallel to the fluid supply system 608. For example, the manifolds of each battery module 602, 604, and 606 may each fluidly connect directly to fluid supply system 608.

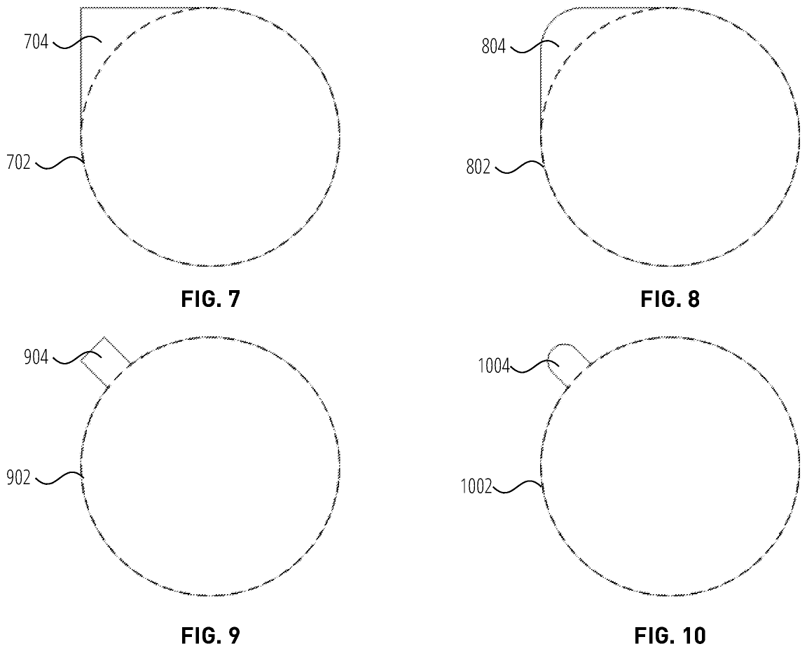

FIG. 7, FIG. 8, FIG. 9, and FIG. 10 show various examples of an opening of a battery cell holder, in accordance with some embodiments.

In FIG. 7, the opening 702 may have a tear-drop shape. The extended portion 704 may be formed from a point that extends away from the circular portion of the opening 702.

In FIG. 8, the opening 802 may have a rounded tear-drop shape. The extended portion 804 may be formed from a rounded corner that extends away from the circular portion of the opening 802.

In FIG. 9, the opening 902 may include a rectangular or three-sided extension 904. The extended portion 904 may be formed from a three-sided shape that extends away from the circular portion of the opening 902.

In FIG. 10, the opening 902 may include an oblong extension 1004. The extended portion 1004 may be formed from a oblong shape that extends away from the circular portion of the opening 1002.

As with each of these examples, the circular portion may be sized to accommodate the size and shape of a cylindrical battery cell. The extended portion may be sized and shaped based on other considerations such as the flow rate and thermal requirements of the battery module.

It should be understood that other geometries may be implemented for the openings that include a circular portion and a second portions that extends away from the circular portion, without departing from the scope of the present disclosure.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, a thermal connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A battery module comprising:
a plurality of battery cells; and
a cell holder comprising a plurality of openings that extends from a first surface of the cell holder to an opposite surface of the cell holder, each of the plurality of openings comprising a cross-section with a circular portion and an extended portion that extends from the circular portion,
wherein each of the plurality of battery cells are housed in a respective one of the plurality of openings and a space between each of the plurality of battery cells and an interior surface of each of the plurality of openings of the cell holder is to form a path for a fluid to flow along a length of a respective one of the plurality of battery cells, the path including at least the extended portion of a respective one of the plurality of openings.

2. The battery module of claim 1, wherein one or more channels are fluidly connected to the plurality of openings at the first surface of the cell holder, to deliver the fluid to each of the plurality of openings.

3. The battery module of claim 2, wherein adjacent openings are arranged in the cell holder to form one or more groups of openings, each of the adjacent openings having a respective extended portion that is directed towards a common region between the adjacent openings.

4. The battery module of claim 3, wherein each of the one or more groups of openings is formed by three adjacent openings.

5. The battery module of claim 3, wherein the one or more groups of openings includes a plurality of groups of openings that are side-by-side to form a repetitive pattern.

6. The battery module of claim 3, wherein each of the one or more channels directs the fluid to a respective common region of a respective one of the one or more groups of openings.

7. The battery module of claim 1, further comprising:
a supply manifold that is fluidly connected to each of the plurality of openings at the first surface of the cell holder; and
a return manifold that is fluidly connected to each of the plurality of openings at the opposite surface of the cell holder,
wherein the supply manifold includes a first supply port, and the return manifold includes a first return port, and the first supply port and the first return port are arranged on a first side of the battery module.

8. The battery module of claim 7,
wherein the supply manifold includes a second supply port, and the return manifold includes a second return port, and the second supply port and the second return port are arranged on a second side of the battery module that is different from the first side of the battery module, and
wherein the fluid is to flow from the first supply port to the second supply port and from the second return port to the first return port when a second battery module is fluidly connected to the battery module via the second supply port and the second return port.

9. The battery module of claim 1, wherein the cell holder comprises a first layer that forms the first surface of the cell holder, a second layer that forms the opposite surface of the cell holder, and an extruded layer that is fixed between the first layer and the second layer.

10. The battery module of claim 1, wherein the cross-section includes a tear-drop shape with the extended portion formed from a point that extends away from the circular portion.

11. The battery module of claim 1, wherein a geometry of the cell holder is configured to provide a thermal transfer up to a first threshold and limit an amount of fluid through the battery module to a second threshold.

12. The battery module of claim 1,
wherein one or more channels are fluidly connected to the plurality of openings at the first surface of the cell holder, to direct the fluid to each of the plurality of openings and one or more second channels are fluidly connected to the plurality of openings at the opposite surface of the cell holder to receive the fluid from each of the plurality of openings, and
wherein the one or more channels and the one or more second channels have a geometry to increase the fluid flowing to and from the plurality of openings and direct a same amount of the fluid to each of the plurality of battery cells in each of the plurality of openings.

13. The battery module of claim 1, wherein the cell holder includes a low-density filler that compresses in response to an increase in fluid volume, and expands in response to a decrease in a volume of the fluid.

14. An energy storage system comprising a plurality of battery modules, each of the plurality of battery modules comprising:
a plurality of battery cells; and
a cell holder comprising a plurality of openings that extends from a first surface of the cell holder to an opposite surface of the cell holder, each of the plurality of openings comprising a cross-section with a circular portion and an extended portion that extends from the circular portion,
wherein each of the plurality of battery cells are housed in a respective one of the plurality of openings and a space between each of the plurality of battery cells and an interior surface of each of the plurality of openings of the cell holder is to form a path for a fluid to flow along a length of a respective one of the plurality of battery cells, the path including at least the extended portion of a respective one of the plurality of openings.

15. The energy storage system of claim 14, wherein each of the plurality of battery modules comprises one or more channels that are fluidly connected to the plurality of openings at the first surface of the cell holder, to direct the fluid to each of the plurality of openings.

16. The energy storage system of claim 15, wherein adjacent openings are arranged in the cell holder to form one or more groups of openings, each of the adjacent openings having a respective extended portion that is directed towards a common region between the adjacent openings.

17. The energy storage system of claim 16, wherein each of the one or more groups of openings is formed by three adjacent openings.

18. The energy storage system of claim 14, wherein each of the plurality of battery modules further comprises:
a supply manifold that is fluidly connected to each of the plurality of openings at the first surface of the cell holder; and
a return manifold that is fluidly connected to each of the plurality of openings at the opposite surface of the cell holder,
wherein the supply manifold includes a first supply port, and the return manifold includes a first return port, and the first supply port and the first return port are arranged on a first exterior surface of a respective one of the plurality of battery modules.

19. The energy storage system of claim 18,
wherein the supply manifold includes a second supply port, and the return manifold includes a second return port, and the second supply port and the second return port are arranged on a second exterior surface that is different from the first exterior surface, and
wherein the fluid is to flow from the first supply port to the second supply port and from the second return port to the first return port when a first of the plurality of battery modules is fluidly connected to a second of the plurality of battery modules through connecting the first supply port of the second of the plurality of battery modules to the second supply port of the first of the plurality of battery modules and connecting the first return port of the second of the plurality of battery modules to the second return port of the first of the plurality of battery modules.

20. The energy storage system of claim 14, wherein the plurality of battery modules are fluidly connected to each other in series.
